(19) United States
(12) Patent Application Publication
(10) Pub. No.: US 2010/0117996 A1
(43) Pub. Date: May 13, 2010

(54) DISPLAY DEVICE CAPABLE OF PERFORMING LEFT/RIGHT CHANGE DISPLAY AND DISPLAY METHOD THEREOF

(76) Inventor: Sang-hun Kim, Seoul (KR)

Correspondence Address: F. CHAU & ASSOCIATES, LLC, 130 WOODBURY ROAD, WOODBURY, NY, 11797, US

(21) Appl. No.: 11/558,206

(22) Filed: Nov. 9, 2006

(30) Foreign Application Priority Data
Dec. 2, 2005 (KR) 10-2005-0116889

(51) Int. Cl. G06F 3/038

(52) U.S. Cl. 345/204

(57) ABSTRACT

A display device includes a panel to display data and a plurality of chips respectively transmitting the data to transmission regions of the panel according to transmission orders. The transmission regions and transmission orders are fixed. The plurality of chips transmits the data according to changed transmission orders different from the fixed transmission orders in response to an order change signal.

### CROSS-REFERENCE TO RELATED PATENT APPLICATION

This application claims priority to Korean Patent Application No. 10-2005-0116889, filed on Dec. 2, 2005, the disclosure of which is herein incorporated by reference in its entirety.

### BACKGROUND OF THE INVENTION

1. Technical Field

The present disclosure relates to a display device and, more particularly, to a display device capable of performing left/right change display and a display method thereof.

2. Discussion of Related Art

A display device includes chips that transmit data corresponding to an image for display to a display panel. In a display device including two chips, the different transmission regions to which data is transmitted and the data transmission orders of the chips are fixed in hardware. In a display device including two chips, the chips may be divided into a master and a slave according to a set value of a master-slave signal. For example, the display device can recognize a chip for which the master-slave signal is set to a low logic level “L” as the master and recognize a chip for which the aster-slave signal is set to a high logic level “H” as the slave. The data transmission order of the master takes precedence over the transmission order of the slave.

The master and slave chips respectively transmit data for display to the right and left regions of a display panel. The display panel may be equally divided into the right and left regions on the basis of source output directions of the chips. The transmission regions of the display panel to which the master and slave chips transmit data may be recognized according to logic states of a left enable signal and a right enable signal.

FIG. 1A illustrates the data [symbol] displayed on a conventional display device 10. Referring to FIG. 1A, the conventional display device 10 includes two chips (not shown) that transmit data such as [symbol] to a display panel 11. The chips transmit [symbol] and [symbol] to a left region corresponding t. L1 through Ln, and a right region corresponding to R1 through Rn of the display panel 11, respectively. In FIG. 1A, a transmission direction signal XDS is set to a low logic level “L”. The transmission direction signal XDS represents the direction in which the data [symbol] is displayed on the panel 11. When a transmission direction signal XDS, which is at a low logic level “L”, for example, is applied to the display device 10, the display device 10 transmits the data [symbol] from the left to right of the panel 11, as indicated by the arrow in FIG. 1A.

In cases where, for example, the positions of the chips are changed or the display panel is upside-down, left/right change display of the data is required. FIG. 1B illustrates the data [symbol] incorrectly left/right-changed and displayed on the display device 10 of FIG. 1A when the data transmission direction is changed. Referring to FIG. 1B, the transmission direction signal XIS which is at a high logic level “H” is applied to the display device 10 for left/right change display. That is, the logic level of the transmission direction signal XDS of FIG. 1B is different from that of FIG. 1A.

Since the transmission direction signal XDS is at a high logic level “H”, the two chips of the display device 10 (not shown) transmit the data [symbol] from the right to left of the panel 11 for display, as indicated by the arrow in FIG. 1B. That is, as the transmission direction signal XDS is changed from a low logic level “L” to a high logic level “H”, the data [symbol] is transmitted from Ln to L1 and the data [symbol] is transmitted from Rn to R1. As illustrated in FIG. 1B, incorrectly left/right-changed data is displayed on the panel 11. This is because the data [symbol] is not left/right changed for the entire region L1 through Rn of the panel 11, but instead for each of the transmission regions L1 through Ln and R1 through Rn of the two chips. That is, [symbol] and [symbol] are independently left/right-changed.

FIG. 2A illustrates data [symbol] displayed on another display device 20. The operations of the display device 20 correspond to the operations of the display device 10 of FIG. 1A, but the positions of two chips included in the display device 20 and the logic level of the transmission direction signal XDS are different from those of the display device 10 of the FIG. 1A. The data [symbol] is displayed on the display panel as illustrated in FIG. 2A.

is FIG. 2B illustrates the data [symbol] incorrectly left/right-changed and displayed on the display device 20 when the transmission direction is changed. The logic level of the transmission direction signal XDS is inverted from the logic level of the transmission direction signal XDS of FIG. 2A and applied to the display device 20 for left/right change display. The data [symbol] is incorrectly left/right-changed and displayed, as described above with reference to FIG. 1B.

Conventional display devices may incorrectly perform left/right change display of data when the transmission direction of the data to a display panel is changed for the left/right change display.

### SUMMARY OF THE INVENTION

According to an exemplary embodiment of the present invention, there is provided a display device including a panel to display data and a plurality of chips that respectively transmit the data to transmission regions of the panel according to transmission orders. The transmission regions and transmission orders are fixed. The plurality of chips transmits the data according to changed transmission orders different from the fixed transmission orders in response to an order change signal.

The display device may include an order change signal generator that transmits the order change signal to the plurality of chips in response to a transmission direction signal that represents a direction of transmission of the data to the panel.

The display device may include two chips. The panel may be divided into the left and right regions based on source output directions of the chips. The size of the left and right regions may be substantially equal. The two chips may respectively correspond to a master and a slave, wherein a transmission order of the master takes precedence over a transmission order of the slave.

The master and the slave may be determined by a logic state of a master-slave signal. The order change signal may have a logic state different from the logic state of the master-slave signal.

The order change signal generator an exclusive NOR may include a logical gate and first, second and third multiplexers. The logical gate performs an exclusive NOR operation on the transmission direction signal and the master-slave signal and outputs the resultant signal as a first control signal. The first and second multiplexers select one of the master-slave signal or an inverted signal of the master-slave signal in response to the first control signal. The third multiplexer outputs one of the output signals of the first or second multiplexers as the order change signal in response to a second control signal. The second control signal is a left enable signal that enables the left region.

According to an exemplary embodiment of the present invention, there is provided a display method of a display device including a panel to display data and a plurality of chips to transmit data to the panel according to transmission regions and transmission orders, wherein the transmission regions and transmission orders are fixed. The method includes applying changed transmission orders different from the fixed transmission orders to the plurality of chips, and transmitting the data to the transmission regions of the panel according to the changed transmission orders.

The display device may include two chips, wherein the two chips respectively correspond to a master and a slave, and wherein a transmission order of the master takes precedence over a transmission order of the slave.

In the applying the changed transmission orders to the two chips, the transmission order of the slave may be applied to the master and the transmission order of the master may be applied to the slave.

In the applying the changed transmission orders, the changed transmission orders may be applied to the two chips when a direction of transmission of the data to the panel is changed.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 illustrates data displayed on a conventional display device.

FIG. 1b illustrates data wrongly left/right-changed and displayed on the display device of FIG. 1a when a transmission direction is changed;

FIG. 2A illustrates data displayed on a conventional display device.

FIG. 2B illustrates data incorrectly left/right-changed and displayed on the display device of FIG. 2A when a transmission direction is changed.

FIG. 3 is a block diagram of a display device according to an exemplary embodiment of the present invention.

FIG. 4A is a table representing hardware settings for the transmission of data in the display device of FIG. 3, according to an exemplary embodiment of the present invention.

FIG. 4B illustrates data displayed on the display device of FIG. 3 that is set according to the hardware settings of table of FIG. 4A.

FIG. 4C illustrates data correctly left-right-changed and displayed on the display device of FIG. 3, which is set according to the hardware settings of table of FIG. 4A, when a transmission direction is changed.

FIG. 5A is a table representing hardware setting for the transmission of data in the display device of FIG. 3 according to an exemplary embodiment of the present invention.

FIG. 5B illustrates data displayed on the display device of FIG. 3 that is set according to the hardware settings of table of FIG. 5A.

FIG. 5C illustrates data left-right-converted and displayed on the display device of FIG. 3, which is set according to the hardware settings of table of FIG. 5A, when a transmission direction is changed.

FIG. 6 is a circuit diagram of an order change signal generator of FIG. 3, according to an exemplary embodiment of the present invention.

FIG. 7 is a flow chart showing a display method according to an exemplary embodiment of the present invention.

### DESCRIPTION OF EXEMPLARY EMBODIMENTS

Hereinafter, exemplary embodiments of the present invention will be described in detail with reference to the accompanying drawings. Like reference numerals refer to similar or identical elements throughout the description of the figures.

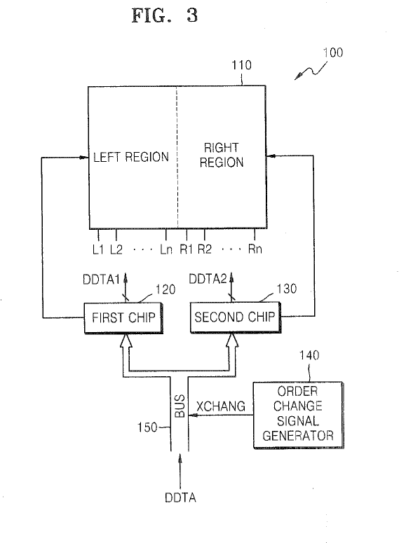

FIG. 3 is a block diagram of a display device 100 according to an exemplary embodiment of the present invention. Referring to FIG. 3, the display device 100 includes a panel 110 and first and second chips 120 and 130. The panel 110 displays data DDTA. The first and second chips 120 and 130 respectively transmit the data DDTA to their transmission regions of the panel 110 according to their transmission orders. The transmission regions and transmission orders of the first and second chips 120 and 130 are fixed, for example, set in hardware. It is to be understood that the display device 100 may include a plurality of chips to transmit the display data.

For example, the first chip 120 transmits a first data part DDTA1 of the data DDTA to the left region L1 through Ln of the panel 110 and the second chip 130 transmits a second data part DDTA2 of the data DDTA to the right region R1 through Rn of the panel 110, where n is a natural number. The panel 110 of FIG. 3 is substantially equally divided into the left region L1 through Ln and the right region R1 through Rn. That is, the sizes of the left region L1 through Ln and the right region R1 through Rn may be substantially equal.

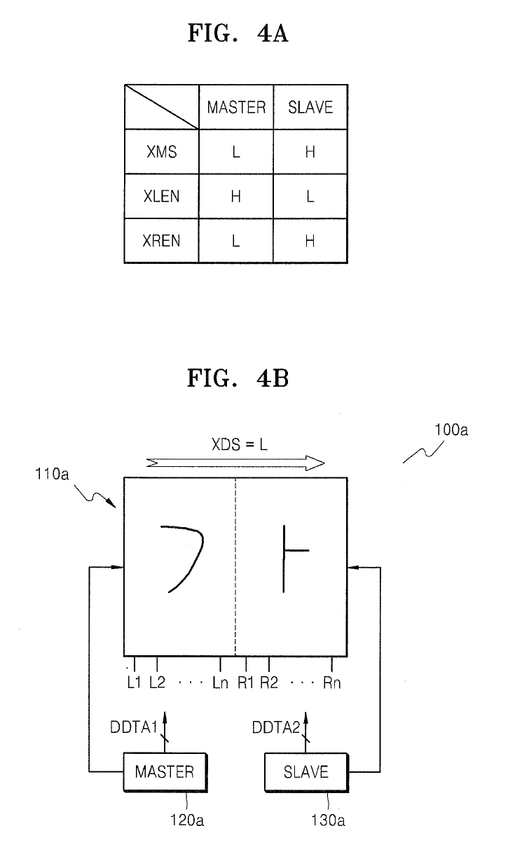

FIG. 4A is a table representing hardware settings for the transmission of the data in the display device 100 of FIG. 3, according to an exemplary embodiment of the present invention. FIG. 4B illustrates data [symbol] displayed on the display device 100 that is set according to the hardware settings of the table of FIG. 4A. Referring to FIGS. 4A and 4B, the two chips 120 and 130 of the display device 100a, according to an exemplary embodiment of the present invention, respectively correspond to a master 120a and a slave 130a. The master 120a and the slave 130a may be determined by logic states of a master-slave signal XMS. For example, a chip for which the master-slave signal XMS is set to a low logic level “L” corresponds to the master 120a, and a chip for which the master-slave signal XMS is set to a high logic level “H” corresponds to the slave 130a.

The transmission order of the master 120a takes precedence over the transmission order of the slave 130a. For example, the master 120a transmits [symbol] and the slave 130a transmits [symbol] to the panel 110a, if the data [symbol] is equally divided into [symbol] and [symbol] .

Referring to FIGS. 4A and 4B, in a case when a left enable signal XLEN of the master 120a and a right enable signal XREN of the slave 130a are set to a high logic level “H”, the master 120a transmits [symbol] to the left region L1 through Ln of the panel 110a and the slave 130a transmits [symbol] to the right region R1 through Rn of the panel 110a.

When a transmission direction signal XDS which is at a low logic level “L” is applied to the display device 100a that is set according to the hardware settings of table of FIG. 4A, the data [symbol] is transmitted from the left to the right of the panel 110a, as indicated by the arrow. That is, the master 120a transmits [symbol] from L1 to Ln and the slave 130a transmits [symbol] from R1 to Rn, and the data [symbol] is displayed as illustrated in FIG. 4B.

FIG. 4C illustrates data properly left/right-changed and displayed on the display device 100 of FIG. 3, which is set according to the hardware settings of table of FIG. 4A, when a transmission direction is changed. Referring to FIG. 4C, the transmission direction signal XDS at a high logic level “H” is applied to the display device 100a for the left/right change display of the data [symbol] . The two chips 120a and 130a transmit the data [symbol] from the right to the left of the panel 110a, as indicated by the arrow. An order change signal XCHAN having a logic state different from the logic state of the master-slave signal XMS is applied to the chips 120a and 130a.

Referring to FIG. 3, the display device 100 includes an order change signal generator 140. The order change signal 140 generates the order change signal XCHAN in response to the transmission direction signal that indicates a direction of transmission of the data DDTA to the panel 110.

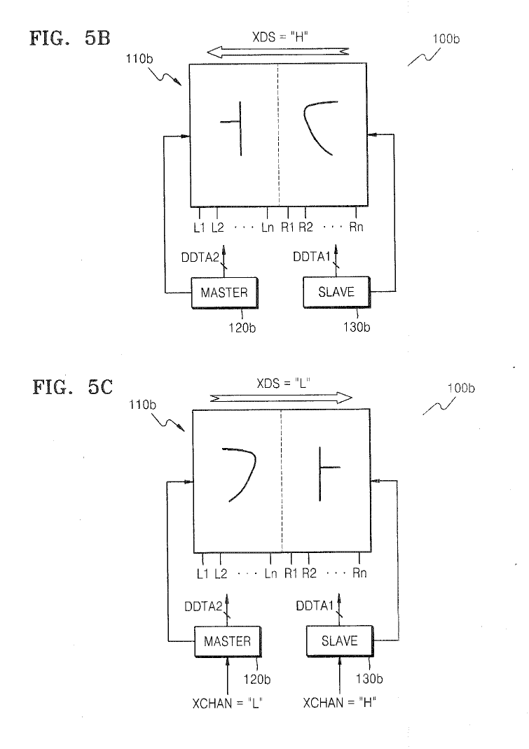

FIG. 6 is a circuit diagram of the order change signal generator 140 of FIG. 3, according to an exemplary embodiment of the present invention. Referring to FIG. 6, the order change signal generator 140 includes an exclusive NOR gate 142 and first, second and third multiplexers 143, 144 and 145. The exclusive NOR gate 142 outputs a signal, which is obtained by performing an exclusive NOR operation on the transmission direction signal XDS and the master-slave signal XMS, as a first control signal XC1. The first and second multiplexers 143 and 144 select either the master-slave signal XMS or an inverted master-slave signal XMS in response to the first control signal. The third multiplexer 145 outputs either the output signal of the first or multiplexer 143 or the output signal of the second multiplexer 144 as the order change signal XCHAN in response to a second control signal XLEN. For example, the second control signal XLEN can be the left enable signal XLEN that enables the left region L1 through Ln.

Hereinafter, the order change signal XCHAN applied to the master 120a when the display device, which is set according to the hardware settings of table of FIG. 4A, performs left/right change display as illustrated in FIG. 4C will be described.

Referring to FIGS. 4A through 4C, the first control signal is at a low logic level “L” because the transmission direction signal XDS is at a high logic level “H” and the master-slave signal XMS of the master 120a is at a low logic level, “L”. The first multiplexer 143 outputs the inverted signal XMSB of the master 120a and the second multiplexer 144 outputs the master-slave signal XMS of the master 120a. In an exemplary embodiment of the present invention, the first multiplexer 143 outputs a logic high signal and the second multiplexer 144 outputs a logic low signal.

The third multiplexer 145 outputs the output signal of the first multiplexer 143 as the order change signal XCHAN when the second control signal XLEN, for example, the left enable signal XLEN of the master 120a, is at a high logic level “H”. For example, the order change signal XCHAN that is at a high logic level “H” is applied to the master 120a of FIG. 4C, and the order change signal XCHAN that is at a low logic level “L” is applied to the slave 130a of FIG. 4C.

In an exemplary embodiment of the present invention, the order change signal XCHAN having a logic state different from that of the master-slave signal XMS is applied to the display device 100a when left/right change display is performed, and the display device 100a recognizes the master 120a as the slave 130a and recognizes the slave 130a as the master 120a. The chips 120a and 130a transmit the data DDTA to the panel 110a according to a transmission order based on the logic state of the order change signal XCHAN, and not according to their fixed transmission orders that may be set in hardware.

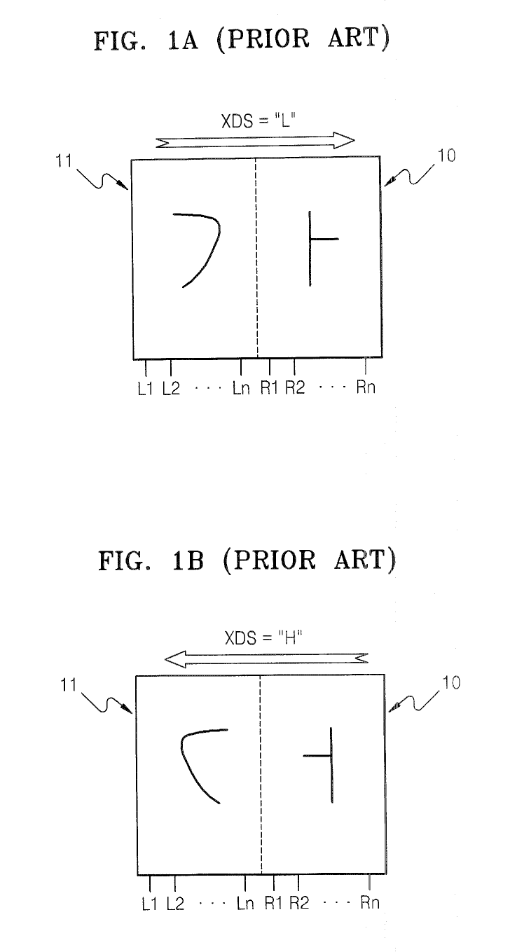

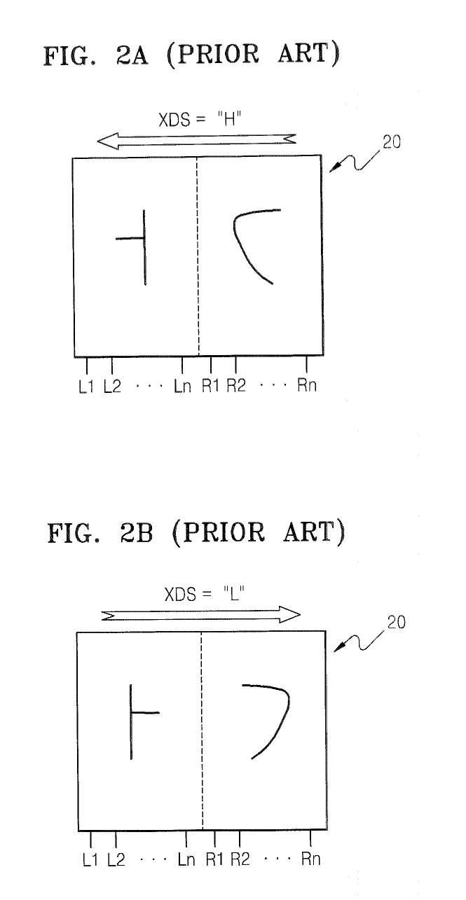

Referring to FIG. 4C, the transmission orders of the chips 120a and 130a are changed according to the order change signal XCHAN, and the transmission order of the slave 130a takes precedence over the transmission order of the master 120a. Accordingly, the slave 130a transmits [symbol] and the master 120a transmits [symbol] and the incorrect left/right change display shown in FIG. 1B is prevented.

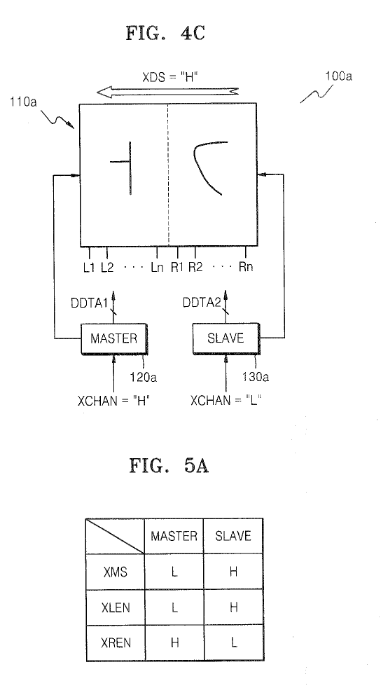

FIG. 5A is a table representing hardware setting f r the transmission of data in the display device of FIG. 3, according to a exemplary embodiment of the present invention. FIG. 5B illustrates the data [symbol] displayed on the display device of FIG. 3 that is set according to the hardware setting of table of FIG. 5A. Referring to FIGS. 5A and 5B, operations of the display device 100b correspond to operations of the display device 100a of FIGS. 4A and 4B, but the positions of the chips 120b and 130b and the logic state of the transmission direction signal XDS are different from those of the display device 100a of FIGS. 4A and 4B. FIG. 5C illustrates data left/right-changed and displayed on the display device of FIG. 3, which is set according to the hardware setting of table of FIG. 5A, when a transmission direction is changed. Referring to FIG. 5C, the logic level of the transmission direction signal XDS is inverted from the logic level of the transmission direction signal XDS in the case of FIG. 5B and applied to the display device 100b for left/right change display. Here, the data [symbol] is correctly left/right changed and displayed, as shown in FIG. 5C, according to operations as described with reference to FIG. 4C.

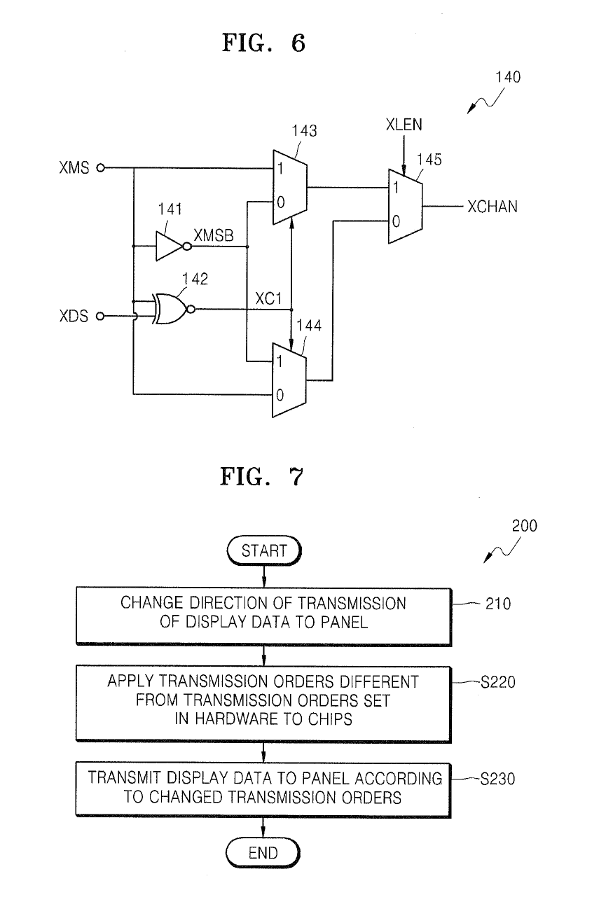

FIG. 7 is a flow chart showing a display method according to an exemplary embodiment of the present invention. Referring to FIG. 7, the display method of a display device including a plurality of chips respectively transmit data to transmission regions of a panel according to the fixed transmission orders includes a step S220 of applying changed transmission orders different from the fixed transmission orders that may be set in the hardware to the plurality of chips and a step S230 of transmitting the data to the panel according to the changed transmission orders.

In an exemplary embodiment of the present invention, there are two chips that respectively correspond to a master and a slave, and the transmission order of the master takes precedence over the transmission order of the slave.

In the step S220, the transmission order of the slave is applied to the master and the transmission order of the master is applied to the slave. When a direction of transmission of the data to the panel is changed in the step S210, transmission orders different from the fixed transmission orders are applied to the plurality of chips.

As described above, the display device and method capable of performing left/right change display according to exemplary embodiments of the present invention change the transmission orders of chips, which may be set in hardware, when a direction of transmission of data to a panel is changed, and left/right change display can be performed in a display device including two chips.

Although exemplary embodiments of embodiments of the present invention have been described in detail with reference to the accompanying drawings for the purpose of illustration, it is to be understood that the inventive processes and apparatus should not be construed as limited thereby: It will be readily apparent to those of ordinary skill in the art that various modifications to the foregoing exemplary embodiments may be made without departing from the scope of the invention as defined by the appended claims, with equivalents of the claims to be included therein.

1. A display device comprising:
a panel to display data;
a plurality of chips that respectively transmit the data to transmission regions of the panel according to transmission orders, wherein the transmission regions and transmission orders are fixed,
wherein each of at least two of the plurality of chips transmit the data according to an order change signal which has a different logic state than the fixed transmission order of the chip, wherein the order change signal is generated in response to a transmission direction signal that represents a direction of transmission of the data to the panel.

2. The display device of claim 1, further comprising an order change signal generator that transmits the order change signal to the plurality of chips in response to the transmission direction signal that represents a direction of transmission of the data to the panel.

3. The display device of claim 2, wherein the panel is divided into the left and right regions based on source output directions of the two chips.

4. The display device of claim 3, wherein a size of the left and right regions of the panel is substantially equal.

5. The display device of claim 4, wherein the two chips respectively correspond to a master and a slave, and wherein a transmission order of the master takes precedence over a transmission order of the slave.

6. The display device of claim 5, wherein the master and the slave are determined by a logic state of a master-slave signal.

7. The display device of claim 6, wherein the order change signal has a logic state different from the logic state of the master-slave signal.

8. The display device of claim 7, wherein the order change signal generator comprises:
a logical gate performing a logical exclusive NOR operation on the transmission direction signal and the master-slave signal and outputting the resultant signal as a first control signal;
first and second multiplexers selecting one of the master-slave signal or an inverted signal of the master-slave signal in response to the first control signal; and
a third multiplexer outputting one of the output signals of the first or second multiplexers as the order change signal in response to a second control signal.

9. The display device of claim 8, wherein the second control signal is a left enable signal that enables the left region.

10. A display method of a display device including a panel to display data and a plurality of chips to transmit data to the panel according to transmission regions of the panel and transmission orders, wherein the transmission regions and transmission orders are fixed, the display method comprising:
applying a changed transmission order to each of at least two of the plurality of chips, wherein the changed transmission order has a different logic state than the fixed transmission order of the chip, wherein the changed transmission order is generated in response to an order change signal that represents a direction of transmission of the data to the panel; and
transmitting the data to the transmission regions of the panel according to the changed transmission orders.

11. The display method of claim 10, wherein the two chips respectively correspond to a master and a slave, and wherein a transmission order of the master takes precedence over a transmission order of the slave.

12. The display method of claim 11, wherein, in the applying the changed transmission orders to the two chips, the transmission order of the slave is applied to the master and the transmission order of the master is applied to the slave.

13. The display method of claim 12, wherein, in the applying the changed transmission orders, the changed transmission orders are applied to the two chips when the direction of transmission of the data to the panel is changed.

14. A display device comprising:
a panel to display data;
a plurality of chips that respectively transmit the data to transmission regions of the panel according to transmission orders, wherein the transmission regions and transmission orders are fixed,
wherein the plurality of chips transmit the data according to changed transmission orders different from the fixed transmission orders in response to an order change signal,
wherein the display device further comprises an order change signal generator that transmits the order change signal to the plurality of chips in response to a transmission direction signal that represents a direction of transmission of the data to the panel,
wherein the display device includes two chips, and wherein the panel is divided into left and right regions based on source output directions of the two chips,
wherein a size of the left and right regions of the panel is substantially equal,
wherein the two chips respectively correspond to a master and a slave, and wherein a transmission order of the master takes precedence over a transmission order of the slave,
wherein the master and the slave are determined by a logic state of a master-slave signal,
wherein the order change signal has a logic state different from the logic state of the master-slave signal, and
wherein the order change signal generator comprises:
a logical gate performing a logical exclusive NOR operation on the transmission direction signal and the master-slave signal and outputting the resultant signal as a first control signal;
first and second multiplexers selecting one of the master-slave signal or an inverted signal of the master-slave signal in response to the first control signal; and
a third multiplexer outputting one of the output signals of the first or second multiplexers as the order change signal in response to a second control signal.

15. The display device of claim 1, wherein the transmission orders correspond to separated transmission regions of the panel.
